(19) United States
(12) Patent Application Publication
(10) Pub. No.: US 2004/0160499 A1
(43) Pub. Date: Aug. 19, 2004

(54) Active ray curable type aqueous ink and image forming method and printed matters by the use thereof

(75) Inventor: Wataru Ishikawa, Tokyo (JP)

Correspondence Address: MUSERLIAN AND LUCAS AND MERCANTI, LLP, 475 PARK AVENUE SOUTH, NEW YORK, NY, 10016, US

(73) Assignee: Konica Minolta Holdings, Inc., Tokyo (JP)

(21) Appl. No.: 10/774,734

(22) Filed: Feb. 9, 2004

(30) Foreign Application Priority Data
Feb. 12, 2003 (JP) 2003-033032

(51) Int. Cl. G01D 11/00

(52) U.S. Cl. 347/100

(57) ABSTRACT

Active ray curable type aqueous ink, which is jetted onto a recording material by a recording head including nozzles which can control the ejection of ink droplets selectively, includes a polymerizable compound which polymerizes with radical polymerization by water and active ray and aqueous photo polymerization initiator which generates radical by active ray and non-ionic surfactant.

### BACKGROUND OF THE INVENTION

1. Field of the Invention

The present invention relates to novel active ray curable type aqueous ink and an image forming method and printed matters by the use thereof, for more detail, active ray curable type aqueous ink which is successful in forming an image at high definition with superior text quality, resistance to color mixing and image flatness, and further, which has superior property to continuous printing, and an image forming method and printed matters by the use thereof.

2. Description of Related Art

In late years, ink jet recording method has been applied for various printing field such as photographs, various type of printing and particular printing such as marking and color filters. In particular, the image quality comparable to a silver salt photography can be obtained in a method which combines a recording device that jets and controls a microscopic dot, ink in which gamut of color reproduction, durability, aptitude for jetting ink and the like are improved, and a special paper in which absorptivity of the ink, color formation property of color materials and surface gloss are remarkably improved. The improvement of image quality of an ink jet type recording method at this time has not accomplished until the recoding device, the ink and the special paper got all together.

However, there are some problems in ink jet system which requires a special paper, that the recording material is limited and costs high. For these reasons, many attempts recording an image to transferring media without the special paper in ink jet method have been made. These are concrete examples: phase changeable ink jet method using solid wax ink at room temperature, solvent system ink jet method using ink mainly consisted of quick-drying solvent and ultraviolet ray curable type ink jet method in which the ink is cross-linked by ultraviolet (UV) light after image recoding.

Among them, the ultraviolet curable type ink jet method is attracting attentions from the viewpoints of lower odor compared with solvent ink jet method, and recordablity to a recoding material which does not have ink absorptivity and property to quick-drying of ink. For examples, Japanese Patent Application Publication (Examined) Tokukouhei-5-54667, Japanese Patent Application Publication (Unexamined) Tokukaihei-6-200204 and Japanese Translation Publication of PCT International Application 2000-504778 Publications disclose ultraviolet ray curable type ink jet ink.

However, many resin compositions used in the ultraviolet ray curable type ink jet ink proposed above are not water-soluble. Thus, known as examples are oil-based ink in which pigments are dispersed in organic solvent such as toluene and methylethylketone and organic compound, and emulsion ink in which nonaqueous resin composition is dispersed in aqueous solvent as emulsion. These oil-based inks require an attention in handling from the environmental view. Further, when the ink is non-solvent ultraviolet ray curable type ink, the application thereof is limited to a printer that prints large dots and has low resolution.

In order to resolve the above-described assignments, a water-soluble resin material (an catalyst and a curable substance to polymerize) in which the ink film cured by active ray has superior physicality and which has consolute property with color materials, is proposed.

A polymerizable compound in which polyethylene oxide chain gives hydrophilic property is known as a water-soluble compound that has two or more curable functional groups, and is manufactured industrially. These compounds have no water solubility when the length of the ethylene oxide chain is short. When the length of ethylene oxide chain is long, though water solubility is obtained, the quality does not fulfill the property such as hardness and adhesiveness of polymerized or cured ink, which is required for active ray curable type ink. Further, Japanese Patent Application Publication (Unexamined) Tokukouhei-8-165441 discloses a multi-functional water-soluble polymerizable compound, and Japanese Patent Application Publication (Unexamined) Tokukai-2000-117960 discloses (meth)acrylic ester of hydrophilic polyepoxide induced from glycerin, and the like, which are put to practical use. Indeed, these compounds have superior polymerization property by ultraviolet ray and physicality of cured material thereof. However the viscosity of these aqueous solutions is higher than the standard which is required for ink jet ink. Therefore, the assignment is still left in obtaining an image of high definition. Further, U.S. Pat. No. 5,612,388, Japanese Patent Application Publication (Unexamined) Tokukaihei-8-165441 and Japanese Patent Application Publication (Unexamined) Tokukai-2000-117960 and the like disclose the proposals with respect to multi-functional cationic acryl monomer. However, these multi-functional cationic compounds do not have compatibility to the dispersing element of aqueous pigment which is dispersed uniformly in aqueous medium, has carboxyl group as dissociation group, and is suitable for a color material of ink, because they have opposite polarity each other. Therefore, it is difficult to be applied to active ray curable type ink.

On the other hand, an aqueous light curable resin composition using a compound comprising two or more curable functional groups and one or two anionic functional groups is proposed (for example, see the claims of Japanese Patent Application Publication (Unexamined) 2002-187918). It is proposed that these components enable to obtain high performance and high quality image. However, it is revealed that the aqueous ink comprising these aqueous light curable resin composition does not have enough stability of ink and wettability to a recording material, that the formed ink image have inferior flatness, and furthermore, that the quality of the printed image degrades when printing is performed continuously for long time period.

As described above, the development of active ray curable type aqueous ink is desired, in which stability to continuous jetting of ink from ink jet recording head is superior, the ink is immediately polymerized by ultraviolet ray irradiation and formed image has high quality (text quality, durability to color mixing, image flatness).

### SUMMERY OF THE INVENTION

The object of the present invention is to provide an active ray curable type ink that the image of high definition with superior text quality, durability to color mixing and image flatness can be formed and property to continuous printing is superior, and the image forming method and the printed matters by use thereof.

The above-described object of the present invention is accomplished by the following composition.

According to the first aspect of the present invention, active ray curable type aqueous ink, which is jetted onto a recording material by a recording head comprising nozzles which selectively controls ejection of ink droplets, and is subsequently cured by irradiation of active ray, comprises:

an aqueous light curable type resin composition including a polymerizable compound which polymerizes with radical by water and active ray, and aqueous photo polymerization initiator which generates free radicals by active ray; and a non-ionic surfactant.

The non-ionic surfactant is preferably a fluorine system surfactant comprising perfluoroalkyl group in a molecule.

The content of the non-ionic surfactant is preferably 10 to 10,000 ppm.

According to the second aspect of the present invention, in an image forming method, active ray curable type aqueous ink which is cured by active ray is jetted onto a recording material by a recording head comprising nozzles which selectively controls ejection of ink droplets, wherein the active ray curable type aqueous ink comprises an aqueous light curable type resin composition comprising a polymerizable compound which polymerizes with radical polymerization by water and active ray, and aqueous photo polymerization initiator which generates free radicals by active ray, and non-ionic surfactant.

The non-ionic surfactant is preferably fluorine system surfactant comprising perfluoroalkyl group in a molecule.

The active ray curable type aqueous ink preferably contains the non-ionic surfactant of 10 to 10,000 ppm.

According to the third aspect of the present invention, printed matter is produced in a method in which the above-described active ray curable type aqueous ink is jetted onto an unabsorbent recording material.

According to the fourth aspect of the present invention, printed matter is produced in the above-described image forming method using an absorbent recording material.

According to the fifth aspect of the present invention, printed matter is produced in the above-described image forming method using an unabsorbent recording material.

According to the sixth aspect of the present invention, printed matter is produced in the above-described image forming method using an absorbent recording material.

### BRIEF DESCRIPTION OF THE DRAWINGS

The present invention will become fully understood from the detailed description given hereinbelow and the appended drawings which given by way of illustration only, and thus are not intended as a definition of the limits of the present invention, and wherein;

FIG. 1 is a front view showing an example of structure of main parts according to the recording apparatus used in the present invention.

### DETAILED DESCRIPTION OF THE PREFERRED EMBODIMENTS

The present inventors studied about above-described problem, and as a result, found out active ray curable type aqueous ink, which is jetted onto a recording material by a recording head comprising nozzles which selectively controls the ejection of ink droplets and is subsequently cured by irradiation of active ray, comprises an aqueous light curable type resin composition including a polymerizable compound which polymerizes with radical polymerization by water and active ray, and aqueous photo polymerization initiator which generates free radicals by active ray, and a non-ionic surfactant, and found out that the ink enable to form an image at high definition with superior text quality, no color mixing and fine image flatness and superior property to continuous printing, and the image forming method and the printed matter by the use thereof. Thus, the inventors have accomplished the present invention.

In addition to the above-described structure, an objective effect of the present invention is further obtained when fluorine system surfactant having perfluoroalkyl group in the molecule is used as non-ionic surfactant, the concentration of the non-ionic surfactant is 10 to 10,000 ppm and when an unabsorbent recording material is used.

Hereinafter, the present invention will be explained in detail.

The active ray curable type aqueous ink (hereinafter, simply referred to as the ink) comprises an aqueous light curable type resin composition including a polymerizable compound which polymerizes with radical by water and active ray, and aqueous photo polymerization initiator which generates free radicals by active ray; and a non-ionic surfactant.

First, the polymerizable compound in the present invention which polymerizes with radical polymerization by active ray will be explained in detail.

Polymerizable compounds available in the present invention are preferably water-soluble. Compounds having both acidic group and either (meth) acryroil group or vinyl group, concretely such as succinic anhydride, 2-hydroxyethl(meth)acrylate ester, orthophtharic anhydride, 2-hydroxyethl(meth)acrylate ester, vinyl naphthalene sulfonic acid and the like, are examples.

As for the compounds having two or more curable functional groups in single molecule that is manufactured industrially, polymerizable compound in which polyethylene oxide chain gives hydrophilicity is known. (meth)acrylic acid ester of multivalent alcohol and the like such as diethyleneglycol di(meth)acrylate and tetraethyleneglycol di(meth)acrylate are given as an example. The multi-functional aqueous polymerizable compound disclosed in Japanese Patent Application Publication (Unexamined) Tokukaihei-8-165441, the (meth)acrylic ester of hydrophilic polyepoxide induced from glycerin disclosed in Japanese Patent Application Publication (Unexamined) Tokukai 2000-117960 and the multi-functional cationic acryl monomer disclosed in U.S. patent application Ser. No. 5,612,388 are also preferable polymerizable compound.

More preferable polymerizable compounds used in the present invention will be explained. As for the polymerizable compounds, hydrophilic multi-functional polymerizable compounds such as stated as follows can be given. These compounds are highly hydrophilic, water soluble and curable and have high polymerization rate, and furthermore, have low viscosity. Viscosity of the solution thereof is also remarkably lower than the compound according to an earlier development.

As for the polymerizable compound that polymerizes with radical polymerization by light, the water-soluble polymerizable compound selected from following general formula groups A and B can be given.

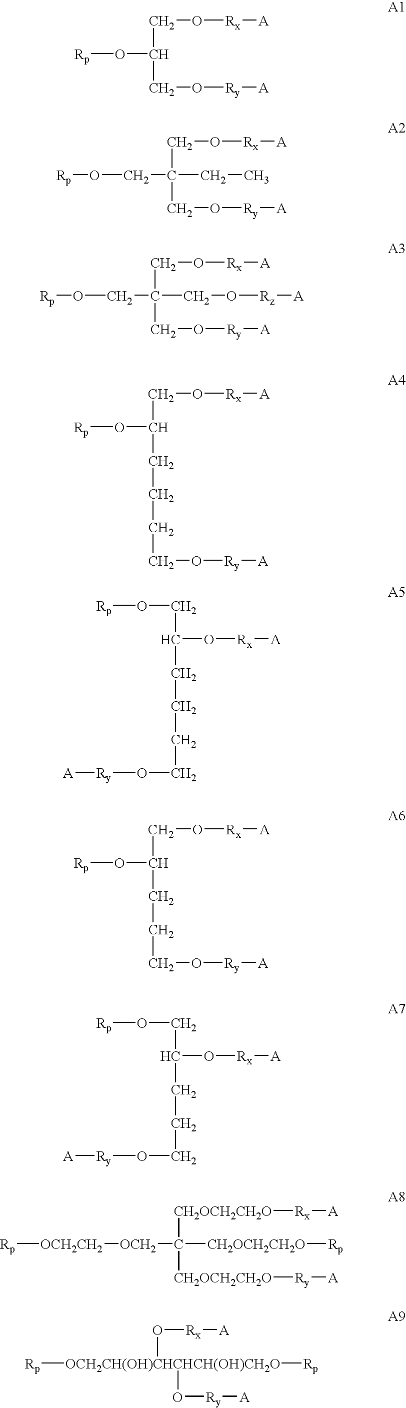

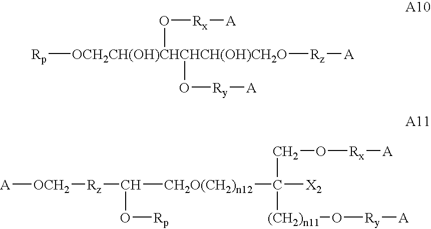

Where X₂ represents H, CH₃ or C₂H₅, n11 represents an integer of 1 to 5, and n12 represents 0 or 1.

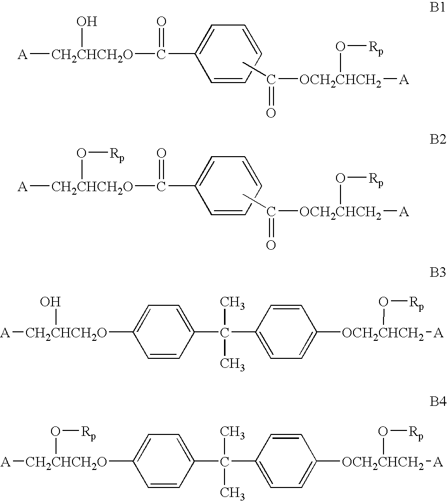

A, Rp, Rx, Ry and Rz shown in the general formulas A represent following atomic groups.

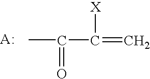

Rx,Ry,Rz: —(CH₂CH₂O)ₙ₁-(coupling with A)

OR

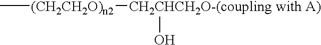

Rp: one selected from following (1) to (5)

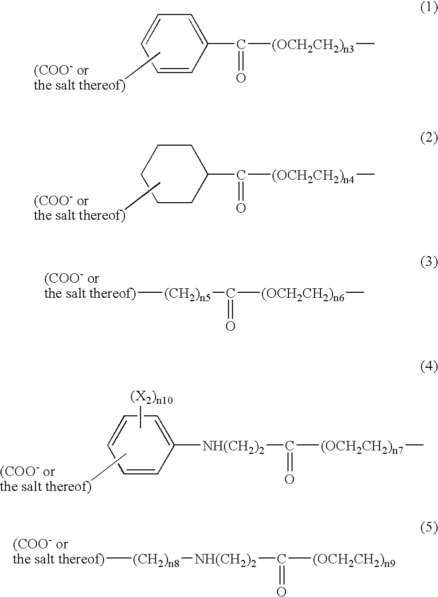

Where X represents H or CH₃; X₂ represents halogen, alkoxyl group or nitro group; n1, n2, n3, n4, n6, n7 and n9 represent an integer of 0 to 5 respectively; n5 represents an integer of 2 to 6; n10 represents an integer of 1 to 4; and n8 represents an integer of 1 to 6.

A and Rp shown in the general formulas B represent following atomic groups.

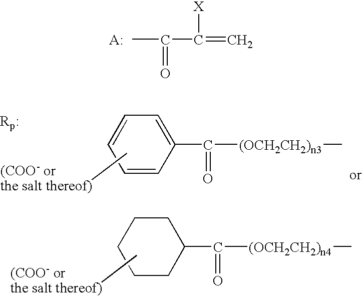

Where X represents H or CH₃, and n3 and n4 represent an integer of 0 to 5 respectively.

The concrete examples of aqueous polymerizable compound selected from general formula groups A and B will be shown below.

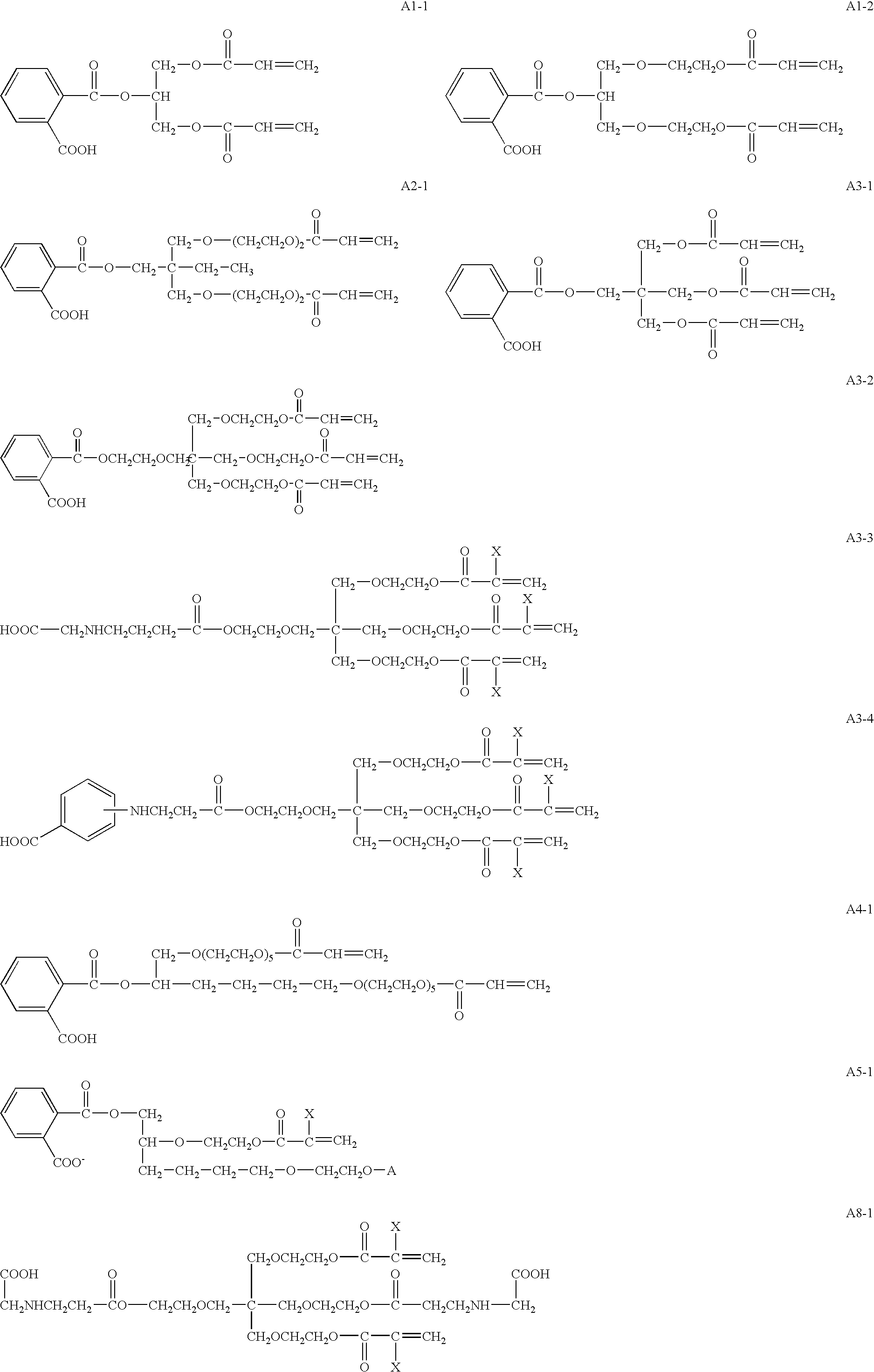

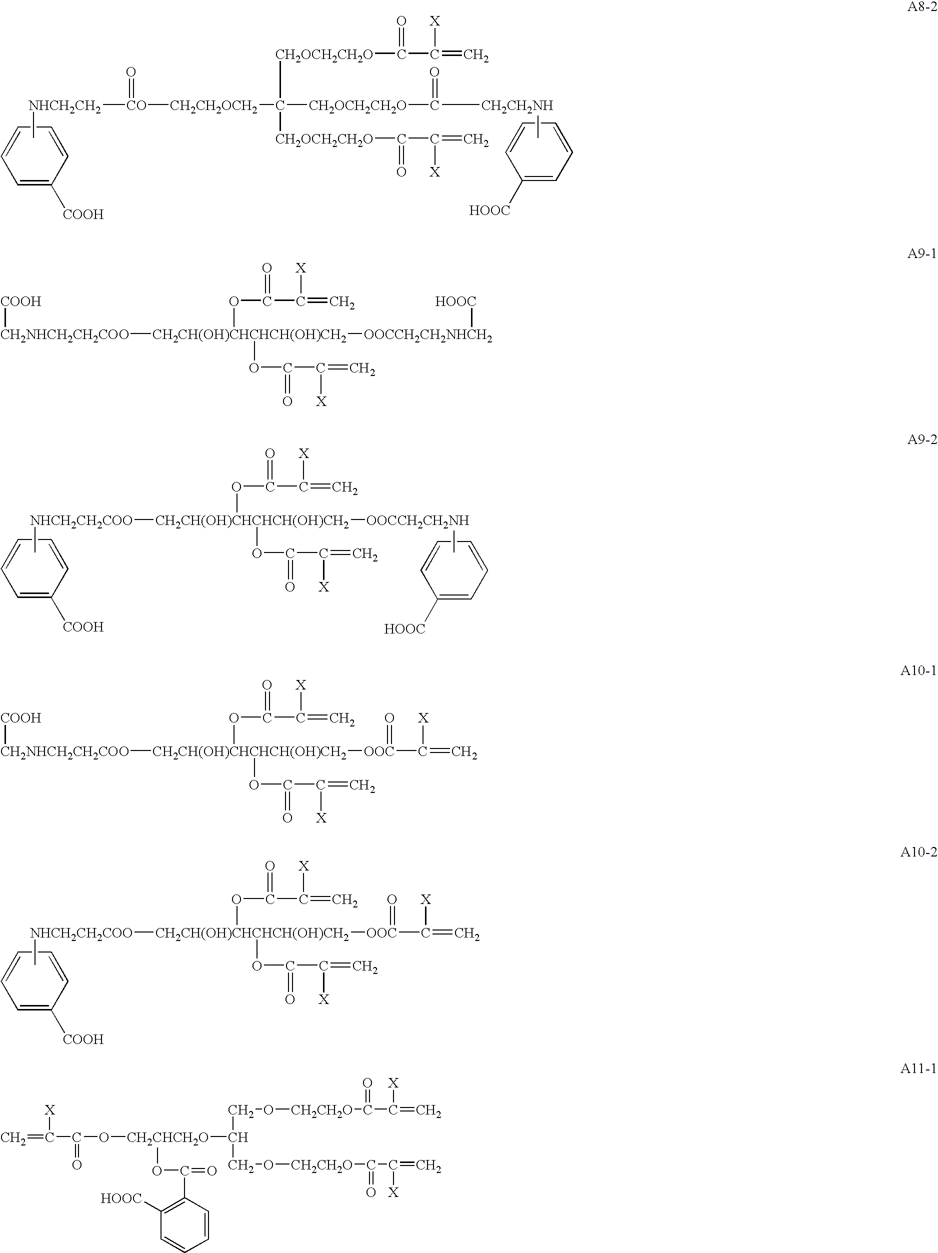

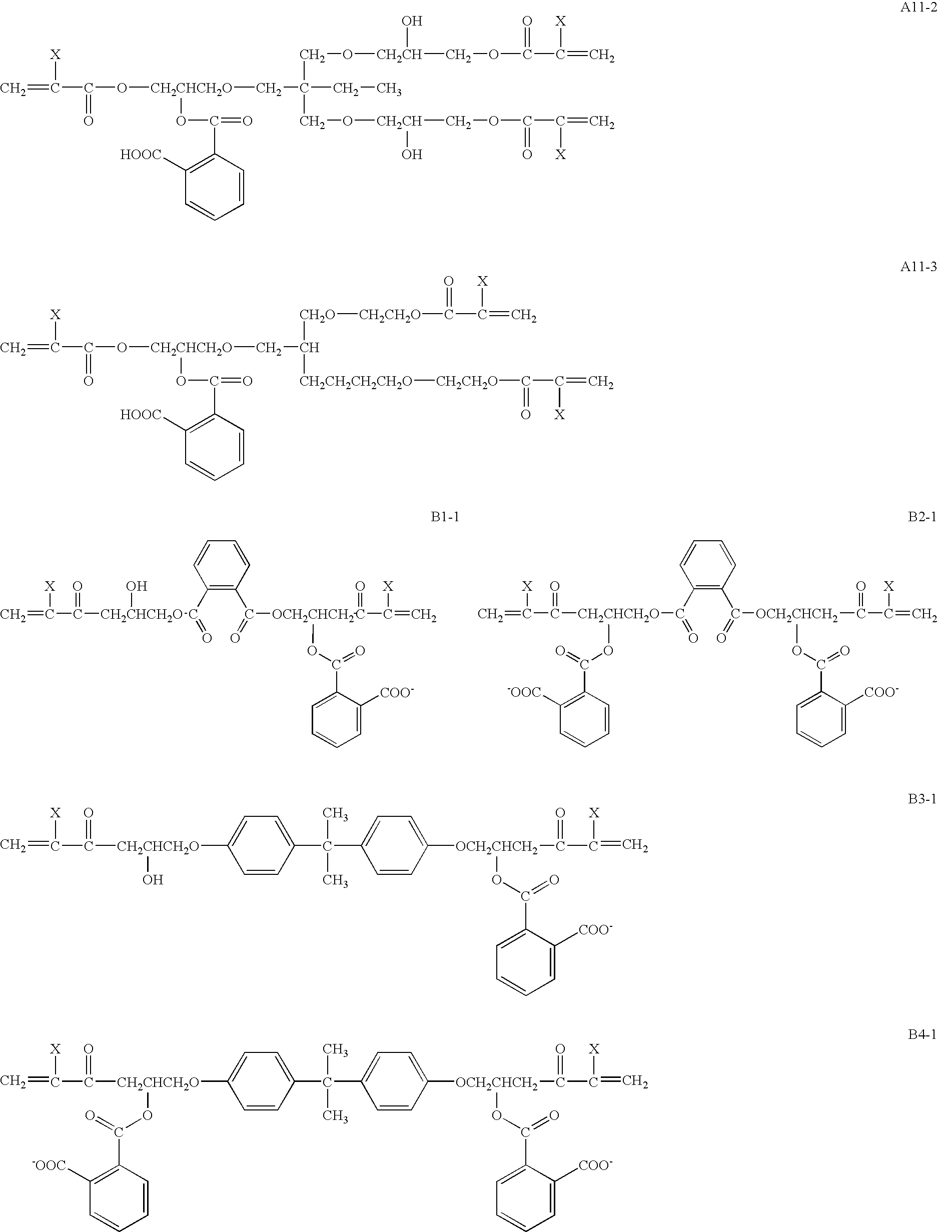

In general formula groups A and B, Xs represent H or CH₃ respectively.

The exemplified polymerizable compounds such as A10-1 and A10-2 and the like can be manufactured by adding amin agent having carboxyl group, or amic acid in a broad sense, to vinyl group of acrylic acid. As for the amin having carboxyl group used in this method, para-aminobenzoic acid, glycine, valine, leucine, isoleucine, serine, threonine, methionine and phenylalanine can be given as examples. Amino acid having two carboxyl groups such as glutamic acid and aspartic acid and the like can be induced to the substances of same performance.

Among a great number of groups of compounds, compounds having three curable function groups in a molecule have superior polymerization rate, hardness of hardened material thereof and water resist frictionality. As for the reason of such trend, it is suggested that the hydrophilicity highly decrease and the density of cross-linking is high when a compound having three or more reactive group polymerizes.

Next, aqueous photo polymerization initiator included in aqueous light curable type resin composition in the present invention will be explained.

As for the aqueous photo polymerization initiator available in the present invention, though there is no specific restriction, a catalyst reacting in about 400 nm wavelength range can be given as an example. As for such catalyst, the photo polymerization initiator represented in following general formula (hereinbelow abbreviated to as TX system) which has the sensitivity in long wavelength range, that is, ultraviolet ray induces radical generation, can be given as an example. It is particularly preferable that the photo polymerization initiator in the present invention is properly selected from them.

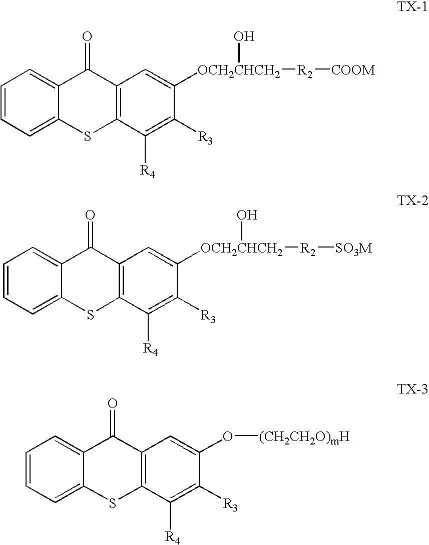

In the above-described general formulas TX-1 to TX-3, R₂ represents —(CH₂)ₓ—(x=0 or 1), —O—(CH₂)_{y}— (y=1 or 2) or substituted or un-substituted phenylene group. When the R₂ is phenylene group, at least one hydrogen atom in the benzene ring can be substituted with one or more groups or atoms selected from carboxyl group or carboxylate, sulfonic acid or sulfonate, linier or branched alkyl group of 1 to 4 carbon atoms, halogen (fluorine, chlorine, bromine and the like), alkoxyl group of 1 to 4 carbon atoms, aryloxy group such as phenoxy group and the like. M represents hydrogen or alkali metal (for example, Li, Na, K and the like). R₃ and R₄ represent hydrogen or substituted or un-substituted alkyl group respectively, where the alkyl group, linear or branched alkyl group of 1 to 10 carbon atoms, especially 1 to 3 carbon atoms, can be given as the examples. As the substituent of the alkyl group, halogen (fluorine, chlorine, bromine and the like), hydroxyl group, alkoxyl group (1 to 3 carbon atoms) can be given as examples. m represents integral number of 1 to 10.

The thioxanthone substituted with these hydrophilic atomic groups has compatibility to dispersion element of water-soluble and anion system aqueous pigment, and has low effect of absorption of organic pigment itself, thus works as sensitive catalyst in pigment system composition.

Furthermore, an aqueous derivative of the photo polymerization initiator Irgacure2959 (Ciba Specialty Chemicals, Japan) represented in the following general formula can be applied as photo a polymerization initiator included in aqueous light curable type resin composition in the present invention. Concretely, IC-1 to IC-3 of the following formulas can be applied.

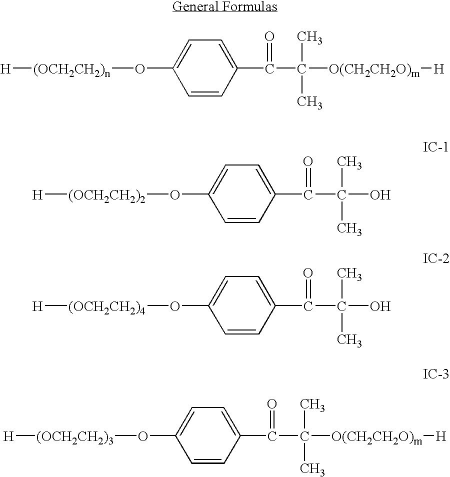

Where n represent an integer of 2 to 5 and m represents an integer of 0 to 5.

The above-described IC-1 to IC-3 are non-ionic and sensitive for ultraviolet ray of shorter wavelength range than that of the photo polymerization initiators shown as TX-1 to TX-3. Further, since IC-1 to IC-3 are water-soluble as well as the above described TX-1 to TX-3, they are useful as a component of the aqueous light curable resin composition according to the present invention. In addition, it seems possible that aqueous derivative manufactured from prior catalysts used in ultraviolet ray polymerization system (photo polymerization initiator) are available as the photo polymerization initiator included in aqueous curable type resin composition in the present invention.

Subsequently, non-ionic surfactant in the present invention will be explained.

The ink of the present invention comprises non-ionic surfactant. As for the non-ionic surfactant in the present invention, acrylic resin which is a copolymer of unsaturated monomer with hydroxyl group such as polyoxyethylene-polyoxypropylene condensate, polyoxyethylene laurylether, secondary alcohol ethoxylate, primary alcohol ethoxylate, nonylphenol ethoxylate, octylphenol ethoxylate, oleylalcohol ethoxylate, lauryl alcohol ethoxylate, polyethylene glycol, polyoxyethylene glycololate, sorbitan stearyl ester, sorbitan oleyl ester, polyoxyethylene sorbitan oleyl ester, methacrylic acid 2-hydroxyethyl, acrylic acid 4-hydroxybuthyl and polyethylene glycol monomethacrylate can be given as examples. Further, alcohol, glycol ether and the like such as isopropyl alcohol, n-butyl alcohol, propylene glycol monomethyl ether, propylene glycol monobutyl ether also can be given. The non-ionic surfactant can be either single component or mixture of two or more.

The concentration of the non-ionic surfactant in the present invention in the ink is preferably 10 to 10,000 ppm, more preferably 20 to 1,000 ppm.

In the present invention, fluorine system surfactant having perfluoroalkyl group in the molecule thereof is more preferable as non-ionic surfactant. It can be thought this relates to electrical property and molecular property of fluorine atom and perfluoroalkyl group. As for a fluorine system surfactant having perfluoroalkyl group in the molecule in the present invention, perfluoroalkylethyleneoxide additive, perfluoroalkylamineoxide and perfluoroalkyl-included oligomer can be given as examples. As concrete examples, “SURFLON S-141”, “SURFLON S-145”, “SURFLON S-381”, “SURFLON S-383”, “SURFLON S-393”, “SURFLON SC-101”, “SURFLON SC-105”, “SURFLON KH-40”, “SURFLON SA-100” (SEIMI CHEMICAL Co., Ltd., Japan), “MEGAFACE F-171”, “MEGAFACE F-172”, “MEGAFACE F-173”, “MEGAFACE F-177”, “MEGAFACE F-178A”, “MEGAFACE F-178K”, “MEGAFACE F-179”, “MEGAFACE F-183”, “MEGAFACE F-184”, “MEGAFACE F-815”, “MEGAFACE F-470” and “MEGAFACE F-471” (DAINIOPPON INK AND CHEMICALS INCORPORATED, Japan) can be given. Compounds shown in page 1239 to 1242 of “13700 no-kagakusyouhin” (The Chemical Daily Co., Ltd., Japan, 2000) also can be given. Fluorine system surfactant having perfluoroalkyl group in the molecule thereof in the present invention can be either single component or mixture of two or more.

Next, the components of active ray curable type aqueous ink except above-described components will be explained.

According to the ink in the present invention, color materials are added in order to dye the ink composition. Various kinds of color materials that are soluble or dispersible to a main ingredient of a polymerizable compound are available. However pigments are preferable from the viewpoint of durability.

The pigments preferably used in the present invention will be stated below.

C. I Pigment Yellow-1, 3, 12, 13, 14, 17, 81, 83, 87, 95, 109, 42,

C. I Pigment Orange-16, 36, 38,

C. I Pigment Red-5, 22, 38, 48:1, 48:2, 48:4, 49:1, 53:1, 57:1, 63:1, 144, 146, 185, 101,

C. I Pigment Violet-19, 23,

C. I Pigment Blue-15:1, 15:3, 15:4, 18, 60, 27, 29,

C. I Pigment Green-7, 36,

C. I Pigment White-6, 18, 21,

C. I Pigment Black-7.

Further, white ink is available in order to increase concealment property of color when a printing material is transparent such as a plastic film. In particular, it is preferable to use white ink in flexible package printing and label printing. However there is a limit to the quantity of the ink consumed from the viewpoint of above-described stability of jetting and generation of curling and wrinkle of recording material.

In order to disperse above-described pigments, for example, ball mill, sand mill, attritor mill, roll mill, agitator, Henschel mixer, colloidal mill, ultrasonic homogenizer, pearl mill, wet type jet mill, paint shaker and the like can be used. In addition, dispersing agent can be added when a pigment is subject to be dispersed. It is preferable to use dispersing polymer, and Solsperse series manufactured by Avecia Co. can be given as the dispersing polymer. A variety of synergists according to each pigment are available as dispersing auxiliary. 1 to 50 parts by mass of the dispersing agent and a dispersing auxiliary are preferably added with respect to 100 parts by mass of a pigment. Solvent and polymerizable compound are given as dispersive medium. However active ray curable type aqueous ink in the present invention preferably contains no solvent because the ink reacts and cures just after placement. If the solvent is left in a cured image, degradation of property to solvent resistance, and volatile organic compounds (VOC) of the residual solvent occurs as problems. Therefore, the dispersive medium is not selected from solvent but preferably from polymerizable compound. Among them, monomer of having the lowest viscosity is particularly preferable from a viewpoint of dispersing property.

With respect to dispersion of the pigment, the average particle size is preferably 0.08 μm to 0.5 μm, and the maximum particle size is 0.3 μm to 10 μm, preferably 0.3 μm to 10 μm. Pigments, dispersing agent and dispersing medium are selected and dispersing and filtering condition are set in order to control the particle size. This control of the particle size prevents clogging of head nozzle, and keeps conservation stability, and transparency of the ink and sensitivity to curing of the ink.

In the present invention, the concentration of color material is preferably 1 to 10 mass % of whole ink.

A variety of additives in addition to above-described substrates can be applied to the ink of the present invention. For example, polymerization inhibiter can be added to be 200 ppm to 20000 ppm in order to improve shelflife of the ink composition. It is preferable to add polymerization inhibitor in order to prevent clogging of head nozzle caused by heat polymerization because ultraviolet ray curable type ink is preferably jetted with heated and to lower the viscosity. In addition, surfactants, leveling additives, matting agents, polyester system resins in order to regulate membrane property, polyurethane system resins, vinyl system resins, acryl system resins, rubber system resins, a type of waxes can be added according to need. It is also effective to add very small amount of organic solvent in order to improve adhesiveness with a recording media. In this case, it is effective that the amount is within the range where problems of resistance property to solvent and VOC do not occur. Thus, the amount thereof is in a range of 0.1 to 5%, preferably 0.1 to 3%.

Next, the image forming method of the present invention will be explained.

In the image forming method of the present invention, the following method is preferable: the above-described ink composition is jetted and drawn on a recording material in ink jet recording method, successively active ray such as ultraviolet ray is irradiated in order to cure the ink.

In the present invention, it is preferable that the droplet volume jetted from each nozzle is 2 pl to 15 pl. The droplet volume is fundamentally needs to be in this range in order to form an image of high definition. However, it is particularly difficult to keep the above-described jetting stability when the droplets of such volume are jetted. According to the present invention, jetting stability is improved and an image of high definition can be formed even if the jetted droplet of the ink is such small volume of 2 to 15 pl.

According to the image forming method in the present invention, light irradiation is performed after the ink of the present invention is adhered to a recording material. The light irradiation can be visible light irradiation or ultraviolet ray irradiation, preferably ultraviolet ray irradiation. In ultraviolet ray irradiation, the irradiation amount of ultraviolet ray is in the range of 100 mJ/cm² or more, preferably 500 mJ/cm² or more, and 10,000 mJ/cm² or less, preferably 5,000 mJ/cm² or less. It is favorable that the irradiation amount of ultraviolet ray is within the above-described range, because discoloration of coloring agent by ultraviolet irradiation can be prevented as well as curing reaction is sufficiently performed. As for the ultraviolet irradiation device, a metal halide lamp, a xenon lamp, a carbon arc lamp, a chemical lamp, a low-pressure mercury lamp and a high-pressure mercury lamp can be given. For example, commercial products such as H lamp, D lamp, V lamp (Fusion System Co., Ltd.) and the like are available. A metal halide lamp has more continuous spectrum than a high-pressure mercury lamp (main wavelength is 365 nm), high luminous efficiency in a range of 200 to 450 nm, and is rich luminance in long wavelength range. Therefore, metal halide lamp is suitable if pigments are used in ink such as the ink composition of the present invention.

In the image recording method of the present invention, as for the irradiation condition of active ray, it is preferable that active ray is irradiated 0.001 sec to 2.0 sec after placement of the ink, more preferably 0.001 sec to 1.0 sec. It is particularly important that the time interval between the placement of ink and the irradiation is as short as possible in order to form an image of high definition.

As for the irradiating method of active ray, Japanese Patent Application Publication (Examined) Tokukaisho-60-132767 discloses a basic method of irradiating active ray. In this publication, light sources are installed on both ends of a head unit, and the head and the lights are scanned by shuttle method. The irradiation is performed definite period of time after placement of ink. Further, the curing is completed by irradiation from another light source which does not move. U.S. Pat. No. 6,145,979 discloses a method of using fiber optics and a method of irradiating UV light to a recording unit in which collimated light reflects on a mirror plate applied on lateral side of a head unit. Any these irradiating methods are available in the image forming method of the present invention.

Further, irradiation of active ray divided into two steps, in which active ray is irradiated firstly 0.001 to 2.0 sec after placement of ink in above-described method, subsequently irradiated after completion of whole printing, is one of a preferable mode. The irradiation of two steps enables to restrict the contraction of a recording material that occurs during the curing of ink.

Next, the printed matter of the present invention will be explained.

The printed matter of the present invention is produced using an image forming apparatus and the like on an unabsorbent or absorbent recording material with the ink and in the image forming method of the present invention.

It is to be noted that the unabsorbent recording material of the present invention indicates a recording material that does not absorb the ink composition (the ink). In the present invention, unabsorbent recording material is defined as the material showing the ink transition amount in Bristow's method described below of less than 0.1 ml/mm², substantially 0 ml/mm²-

Bristow's method in the present invention is a method of measuring liquid absorption behavior of a paper or a board paper in a short time. For more details, measured is the transition amount (ml/m²) in 40 msec of contact time according to the paper and pulp testing method of J.TAPPI No. 51-87: testing method of liquid absorbability of a paper or a board paper (Bristow's method). Though pure water (ion-exchanged water) is used in the above-described measuring method, aqueous dye of less than 2% can be included in the water in order to facilitate discrimination of the measured area.

As for the unabsorbent recording material in the present invention, a variety of unabsorbent plastics and the films thereof used in so-called flexible packaging, besides coated papers, are available. As examples of plastic film, available are PET (polyethylene terephthalate) film, OPS (orientated polystyrene) film, OPP (oriented polypropylene) film, ONy (oriented nylon) film, PVC (polyvinyl chloride) film, PE (polyethylene) film, TAC (triacetylcellulose) film. Other plastics such as polycarbonate, acrylic resin, ABS (acrylonytrile butadien styrene copolymer), polyacetal, PVA (polyvinyl alcohol) and rubbers are available. Further, metals and glasses are also available. Among these recoding materials, when the image is formed on PET film, OPS film, OPP film, ONy film and PVC film, all of which are shrinkable by heat, the structure of the present invention is effective. Not only these base materials easily curl or deform caused by curing and shrinkage of the ink and heat evolution according to curing reaction, but also it is difficult that the ink film go along with the shrinkage of base material.

It has been a problem that the dot size after placement of ink varies according to recording materials, because the surface energies of plastic films largely differ from each other. According to the structure of the present invention, favorable images in high definition can be formed on wide variety of recording materials in which surface energy is in a range of 35 to 60 mJ/m². The recording material in a range of 40 to 60 mJ/m² of surface energy is more preferable.

The recording material of the present invention includes papers such as fine paper, medium grade paper, plain paper, recycled paper, corrugated paper and the like and materials in which an absorbent layer is formed on the above-described unabsorbent materials or papers.

When absorbent base material is used, it is advantageous because the usage thereof bring about following effects such that: 1) there is no exudation of image to backside, 2) cock ring does not occur, 3) drying time can be reduced, and the like.

Next, the recoding apparatus that is available in the image forming method of the present invention will be explained.

Hereinafter, one of examples of the recording apparatus available in the present invention will be explained with referring to drawings appropriately. It is to be noted that the recording apparatus in the drawings is none other than one embodiment of the present invention and does not limit the recording apparatus of the present invention.

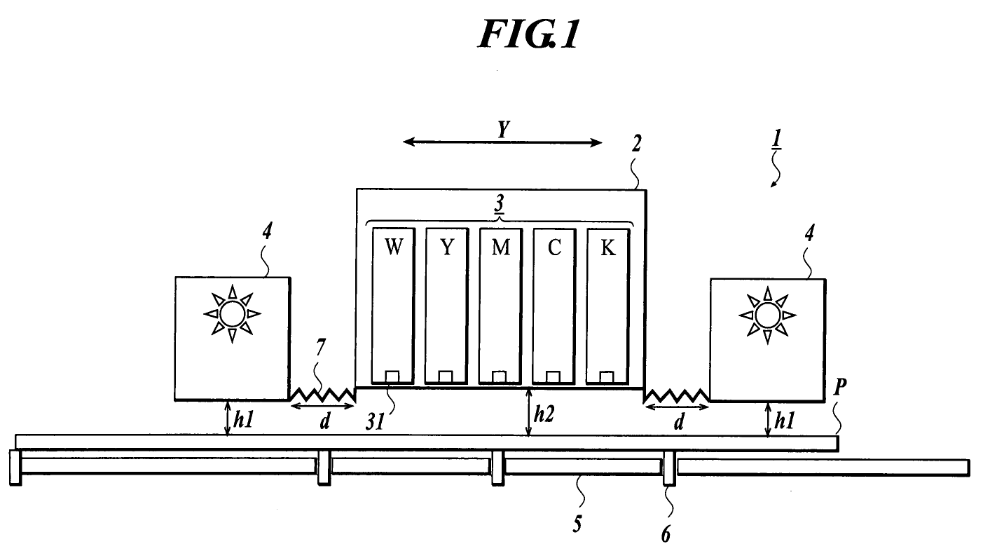

FIG. 1 is an elevation view showing a structure of relevant parts of recording material available in the present invention. The recording apparatus 1 comprises a head carriage 2, a recording head 3, an irradiation member 4, a platen part 5 and the like. The platen part 5 installed to this recording apparatus 1 is placed under the recording material P. The platen part 5 has a function to absorb ultraviolet ray, and absorb excessive ultraviolet ray that transmits through the recording material P. As a result, an image of high definition can be reproduced very stably.

The recording material P guided by a guide member 6 moves from front to back in FIG. 1 by the actuation of carrying members (not shown). The head carriage 2 is reciprocated the head scanning member (not shown) in Y direction in FIG. 1 so that the recording head 3 which the head carriage 2 holds is scanned.

The head carriage 2 is installed on the upper side of the recording material P. A plurality of recording heads 3 are installed in the head carriage 2 according to the number of colors used in image printing on the recording material P, so as to place the jetting nozzle thereof downside. The head carriage 2 is installed to the body of recording apparatus 1 where the head carriage 2 can universally reciprocates in Y direction in FIG. 1, and reciprocates in Y direction in FIG. 1 by actuation of the head scanning member.

The head carriage 2 contains recording heads of white (W), yellow (Y), magenta (M), cyan (C) and black (K) in FIG. 1. However the actual number of recording head 3 contained in head carriage 2 is decided properly on the occasion of implementation.

The recording head 3 jets active ray curable type ink (for example, UV (ultraviolet ray) curable ink), which is provided from ink-provision member (not shown), from jetting nozzle toward recording material P by the actuation of multiple number of jetting member (not shown) which are provided inside the head. The UV curable ink jetted from recording head 3 comprises coloring material, curable monomer, initiator and the like, and is curable by cross linking and polymerization reaction in which the initiator acts as a catalyst when ultraviolet ray is irradiated.

The recording head 3 jets UV curable ink as an ink droplet toward a certain region (ink placeable region) on the recording material P and the ink droplet is placed on the ink placeable region during the scanning of the recording head 3 which moves from one end of recording material P to the other end of that by actuation of the head scanning member.

After the above-described scanning performed proper times so as to jet UV curable ink toward one ink placeable region, the recording material P properly moves from front side toward backside in FIG. 1 by the carrying member. Subsequently the recording head 3 jets UV curable ink again with scanning by the head scanning member toward next ink placeable region that borders on backside of the above-described ink placeable region in FIG. 1.

The above-described operation is repeated in which recording head 3 jets UV curable ink in conjunction with operations of the head scanning member and the carrying member. Thus an image consisting of aggregate of UV curable ink droplets is formed.

Irradiating member 4 comprises the ultraviolet ray lamp which emits ultraviolet ray of specific wavelength range in stable exposure energy and the filter which transmits ultraviolet ray of specific wavelength. The usage of such as black light as radiation source of irradiation member 4 enables to manufacture the irradiating member for curing UV curable ink at low production cost.

The shape and the size of irradiated area by irradiation member 4 is approximately as same as or larger than the ink placeable area which can configure in the recording apparatus (active ray curable type ink jet printer), where the ink placeable area is a area to in which the recording head 3 jets UV curable ink in a single scan by the actuation of head scanning member.

The irradiation member 4 is fixedly installed on the both ends of the head carriage 2 nearly parallel to the recording material P.

As is described above, shading whole part of the recording head 3, moreover extending the distance h2 between ink jetting part 31 of recording head 3 and recording material P larger than the distance h1 between irradiation member 4 and recording material P (h1<h2) and extending the distance d between recording head 3 and irradiation member 4 (longer d) are effective in regulating the luminance at ink jetting part. Further, it is more preferable when accordion-folded structure 7 is installed between the recording head 3 and the irradiation members 4.

The wavelength of ultraviolet ray irradiated by irradiating member 4 is changeable by exchanging the ultraviolet ray lamp or the filter.

### EXAMPLES

Hereinafter, the examples of the present invention will be explained. However, the present invention is not limited to these examples.

### Example 1

<<Preparation of Ink Composition>>

The ink compositions 1 to 8 having the compositions shown in Tables 1-1 and 1-2 are prepared respectively. The numeral numbers shown in Tables 1-1 and 1-2 denote percentages by mass in ink composition.

TABLE 1

| | | TYPE OF INK | | | | |
|---|---|---|---|---|---|---|
| | | K | C | M | Y | W |
| | | TYPE OF COLOR MATERIAL | | | | |
| INK | | COLOR | COLOR | COLOR | COLOR | COLOR |
| COMPOSITION | | MATERIAL | MATERIAL | MATERIAL | MATERIAL | MATERIAL |
| NUMBER | | 1 | 2 | 3 | 4 | 5 |
| 1 | AMOUNT OF COLOR MATERIAL | 15.0 | 15.0 | 15.0 | 15.0 | 15.0 |
| (COMPARATIVE | CURABLE COMPOUND: A3-1 | 31.5 | 31.5 | 31.5 | 31.5 | 31.5 |
| EXAMPLE) | PHOTOINITIATOR: TX-1 | 5.0 | 5.0 | 5.0 | 5.0 | 5.0 |
| | TRIETHANOLAMINE | 0.5 | 0.5 | 0.5 | 0.5 | 0.5 |
| | WATER | 48.0 | 48.0 | 48.0 | 48.0 | 48.0 |
| 2 | AMOUNT OF COLOR MATERIAL | 15.0 | 15.0 | 15.0 | 15.0 | 15.0 |
| (COMPARATIVE | CURABLE COMPOUND: A3-1 | 31.4 | 31.4 | 31.4 | 31.4 | 31.4 |
| EXAMPLE) | PHOTOINITIATOR: TX-2 | 5.0 | 5.0 | 5.0 | 5.0 | 5.0 |
| | TRIETHANOLAMINE | 0.5 | 0.5 | 0.5 | 0.5 | 0.5 |
| | WATER | 48.0 | 48.0 | 48.0 | 48.0 | 48.0 |
| | DETERGENT 1 | 0.1 | 0.1 | 0.1 | 0.1 | 0.1 |
| 3 | AMOUNT OF COLOR MATERIAL | 15.0 | 15.0 | 15.0 | 15.0 | 15.0 |
| (COMPARATIVE | CURABLE COMPOUND: A3-1 | 31.4 | 31.4 | 31.4 | 31.4 | 31.4 |
| EXAMPLE) | PHOTOINITIATOR: TX-2 | 5.0 | 5.0 | 5.0 | 5.0 | 5.0 |
| | TRIETHANOLAMINE | 0.5 | 0.5 | 0.5 | 0.5 | 0.5 |
| | WATER | 48.0 | 48.0 | 48.0 | 48.0 | 48.0 |
| | DETERGENT 2 | 0.1 | 0.1 | 0.1 | 0.1 | 0.1 |
| 4 | AMOUNT OF COLOR MATERIAL | 15.0 | 15.0 | 15.0 | 15.0 | 15.0 |
| (PRESENT | CURABLE COMPOUND: A3-1 | 31.49 | 31.49 | 31.49 | 31.49 | 31.49 |
| INVENTION) | PHOTOINITIATOR: TX-1 | 5.0 | 5.0 | 5.0 | 5.0 | 5.0 |
| | TRIETHANOLAMINE | 0.5 | 0.5 | 0.5 | 0.5 | 0.5 |
| | WATER | 48.0 | 48.0 | 48.0 | 48.0 | 48.0 |
| | DETERGENT 3 | 0.01 | 0.01 | 0.01 | 0.01 | 0.01 |
| 5 | AMOUNT OF COLOR MATERIAL | 15.0 | 15.0 | 15.0 | 15.0 | 15.0 |
| (PRESENT | CURABLE COMPOUND: A3-1 | 31.49 | 31.49 | 31.49 | 31.49 | 31.49 |
| INVENTION) | PHOTOINITIATOR: TX-1 | 5.0 | 5.0 | 5.0 | 5.0 | 5.0 |
| | TRIETHANOLAMINE | 0.5 | 0.5 | 0.5 | 0.5 | 0.5 |
| | WATER | 48.0 | 48.0 | 48.0 | 48.0 | 48.0 |
| | DETERGENT 4 | 0.01 | 0.01 | 0.01 | 0.01 | 0.01 |
| 6 | AMOUNT OF COLOR MATERIAL | 15.0 | 15.0 | 15.0 | 15.0 | 15.0 |
| (PRESENT | CURABLE COMPOUND: A3-1 | 31.49 | 31.49 | 31.49 | 31.49 | 31.49 |
| INVENTION) | PHOTOINITIATOR: TX-1 | 5.0 | 5.0 | 5.0 | 5.0 | 5.0 |
| | TRIETHANOLAMINE | 0.5 | 0.5 | 0.5 | 0.5 | 0.5 |
| | WATER | 48.0 | 48.0 | 48.0 | 48.0 | 48.0 |
| | DETERGENT 5 | 0.01 | 0.01 | 0.01 | 0.01 | 0.01 |
| 7 | AMOUNT OF COLOR MATERIAL | 15.0 | 15.0 | 15.0 | 15.0 | 15.0 |
| (PRESENT | CURABLE COMPOUND: A3-1 | 31.49 | 31.49 | 31.49 | 31.49 | 31.49 |
| INVENTION) | PHOTOINITIATOR: TX-1 | 5.0 | 5.0 | 5.0 | 5.0 | 5.0 |
| | TRIETHANOLAMINE | 0.5 | 0.5 | 0.5 | 0.5 | 0.5 |
| | WATER | 48.0 | 48.0 | 48.0 | 48.0 | 48.0 |
| | DETERGENT 6 | 0.01 | 0.01 | 0.01 | 0.01 | 0.01 |
| 8 | AMOUNT OF COLOR MATERIAL | 15.0 | 15.0 | 15.0 | 15.0 | 15.0 |
| (PRESENT | CURABLE COMPOUND: A3-1 | 31.4 | 31.4 | 31.4 | 31.4 | 31.4 |
| INVENTION) | PHOTOINITIATOR: TX-1 | 5.0 | 5.0 | 5.0 | 5.0 | 5.0 |
| | TRIETHANOLAMINE | 0.5 | 0.5 | 0.5 | 0.5 | 0.5 |
| | WATER | 48.0 | 48.0 | 48.0 | 48.0 | 48.0 |
| | DETERGENT 6 | 0.1 | 0.1 | 0.1 | 0.1 | 0.1 |

TABLE 1-2

| | | TYPE OF INK | | | | |
|---|---|---|---|---|---|---|
| | | K | C | M | Y | W |
| INK | | COLOR | COLOR | COLOR | COLOR | COLOR |
| COMPOSITION | | MATERIAL | MATERIAL | MATERIAL | MATERIAL | MATERIAL |
| NUMBER | TYPE OF COLOR MATERIAL | 1 | 2 | 3 | 4 | 5 |
| 4 | AMOUNT OF COLOR MATERIAL | 15.0 | 15.0 | 15.0 | 15.0 | 15.0 |
| (PRESENT | CURABLE COMPOUND: A3-1 | 31.49 | 31.49 | 31.49 | 31.49 | 31.49 |
| INVENTION) | PHOTOINITIATOR: TX-1 | 5.0 | 5.0 | 5.0 | 5.0 | 5.0 |
| | TRIETHANOLAMINE | 05 | 0.5 | 0.5 | 05 | 05 |
| | WATER | 48.0 | 48.0 | 48.0 | 48.0 | 48.0 |
| | DETERGENTS | 0.01 | 0.01 | 0.01 | 0.01 | 0.01 |
| 5 | AMOUNT OF COLOR MATERIAL | 15.0 | 15.0 | 15.0 | 15.0 | 15.0 |
| (PRESENT | CURABLE COMPOUND: A3-1 | 31.49 | 31.49 | 31.49 | 31.49 | 31.49 |
| INVENTION) | PHOIOINITIATOR: TX-1 | 5.0 | 5.0 | 5.0 | 5.0 | 5.0 |
| | TRIETHANOLAMINE | 0.5 | 0.5 | 0.5 | 0.5 | 0.5 |
| | WATER | 48.0 | 48.0 | 48.0 | 48.0 | 48.0 |
| | DETERGENT 4 | 0.01 | 0.01 | 0.01 | 0.01 | 0.01 |
| 6 | AMOUNT OF COLOR MATERIAL | 15.0 | 15.0 | 15.0 | 15.0 | 15.0 |
| (PRESENT | CURABLE COMPOUND: A3-1 | 31.49 | 31.49 | 31.49 | 31.49 | 31.49 |
| INVENTION) | PHOTOINITIATOR: TX-1 | 5.0 | 5.0 | 5.0 | 5.0 | 5.0 |
| | TRIETHIANOLAMINE | 0.5 | 0.5 | 0.5 | 0.5 | 0.5 |
| | WATER | 48.0 | 48.0 | 48.0 | 48.0 | 48.0 |
| | DETERGENT 5 | 0.01 | 0.01 | 0.01 | 0.01 | 0.01 |
| 7 | AMOUNT OF COLOR MATERIAL | 15.0 | 15.0 | 15.0 | 15.0 | 15.0 |
| (PRESENT | CURABLE COMPOUND: A3-1 | 31.49 | 31.49 | 31.49 | 31.49 | 31.49 |
| INVENTION) | PHOTOINITIATOR: TX-1 | 5.0 | 5.0 | 5.0 | 5.0 | 5.0 |
| | TRIETHANOLAMINE | 0.5 | 0.5 | 0.5 | 0.5 | 0.5 |
| | WATER | 48.0 | 48.0 | 48.0 | 48.0 | 48.0 |
| | DETERGENTS | 0.01 | 0.01 | 0.01 | 0.01 | 0.01 |
| 8 | AMOUNT OF COLOR MATERIAL | 15.0 | 15.0 | 15.0 | 15.0 | 15.0 |
| (PRESENT | CURABLE COMPOUND: A3-1 | 31.4 | 31.4 | 31.4 | 31.4 | 31.4 |
| INVENTION) | PHOTOINITIATOR: TX-1 | 5.0 | 5.0 | 5.0 | 5.0 | 5.0 |
| | TRIETHANOLAMINE | 0.5 | 0.5 | 0.5 | 0.5 | 0.5 |
| | WATER | 48.0 | 48.0 | 48.0 | 48.0 | 48.0 |
| | DETERGENT 6 | 0.01 | 0.01 | 0.01 | 0.01 | 0.01 |

The additives shown in Tables 1-1 and 1-2 are explained below in detail.

K: Black ink

C: Cyan ink

M: Magenta ink

Y: Yellow ink

W: White ink

Color material 1: C. I. pigment Black-7

Color material 2: C. I. pigment Blue-15:3

Color material 3: C. I. pigment Red-57:1

Color material 4: C. I. pigment Yellow-13

Color material 5: titanium oxide (anatase type, average particle size 0.20 μm)

Surfactant 1: cationic surfactant, alkylbenzene dimethylammoniumchloride, Kao Corporation, Japan

Surfactant 2: anionic surfactant, lauryl sulfate, Kao Corporation, Japan

Surfactant 3: non-ionic surfactant, polyoxyethylene laurylether, Japan Emulsion Co., Ltd., Japan

Surfactant 4: non-ionic surfactant, SURFLON S-141, Seimi Chemicals Co., Ltd., Japan

Surfactant 5: Fluorine system non-ionic surfactant, MEGAFACE F-470 (Dainippon Ink and Chemicals Incorporated, Japan)

Surfactant 6: Fluorine system non-ionic surfactant, MEGAFACE F-178K (Dainippon Ink and Chemicals Incorporated, Japan)

The polymerizable compound A3-1 is one described as A3-1 in above formulas, and was synthesized.

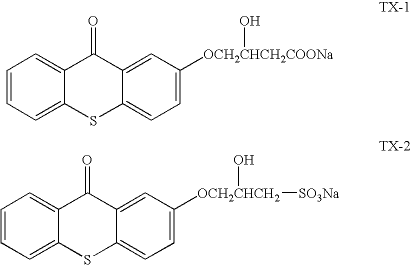

<<Formation of an Ink Jet Image>>

The recording head part uses heat energy inn order to jet ink from ink jet opening. Each ink composition prepared as described above was set in the ink jet recording apparatus such as shown in FIG. 1, which includes a electro-thermal converter as a heat energy generating members, and each image recording described below was performed continuously by the recording head part onto each recording materials shown in Tables 2-1 and 2-2, which are long sheets of 600 mm width and 1000 m length. Ink supply system comprises an ink tank, a feeder pipe, a front-chamber ink tank placed right before the head, a piping with filter and a piezoelectric head. The piezoelectric head was operated so as to consecutively eject the individual inks in multi-dot sizes variable from 2 to 15 pl in a 720 dpi×720 dpi resolution (herein, “dpi” refers to the number of dots per 2.54 cm). The curing process carried out in the irradiation condition shown in Tables 2-1 and 2-2, 0.1 sec after ink droplet placed. This evaluation carried out in a room where temperature was and humidity is controlled at 23° C. and at 40% RH respectively.

TABLE 2

| | | | IRRADIATION CONDITIONS | | | | | |
|---|---|---|---|---|---|---|---|---|
| | | | OF ACTIVE RAY | | | | | |
| | | | IR- | | | | IR- | |
| | INK | | RADIA- | | IR- | MAXIMUM | RADIA- | |
| | COMPO- | | TION | IRRADIATION | RADIA- | ILLUMIN- | TION | |
| SAMPLE | SITION | RECORDING | LIGHT | TIME AFTER | TION | ANCE | ENERGY | |
| NO. | NO. | MATERIAL | SOURCE | PRINTING | METHOD | (mW/cm²) | (mJ/cm²) | REMARKS |
| 1 | 1 | OPP | A | 0.1 SECOND | A | 8.0 | 20.0 | COMPARATIVE |
| | | | | LATER | | | | EXAMPLE |
| 2 | 1 | PET | A | 0.1 SECOND | A | 8.0 | 20.0 | COMPARATIVE |
| | | | | LATER | | | | EXAMPLE |
| 3 | 1 | FINE | A | 0.1 SECOND | A | 8.0 | 20.0 | COMPARATIVE |
| | | PAPER | | LATER | | | | EXAMPLE |
| 4 | 1 | COPIER | A | 0.1 SECOND | A | 8.0 | 20.0 | COMPARATIVE |
| | | PAPER | | LATER | | | | EXAMPLE |
| 5 | 2 | OPP | A | 0.1 SECOND | A | 8.0 | 20.0 | COMPARATIVE |
| | | | | LATER | | | | EXAMPLE |
| 6 | 2 | PET | A | 0.1 SECOND | A | 8.0 | 20.0 | COMPARATIVE |
| | | | | LATER | | | | EXAMPLE |
| 7 | 2 | FINE | A | 0.1 SECOND | A | 8.0 | 20.0 | COMPARATIVE |
| | | PAPER | | LATER | | | | EXAMPLE |
| 8 | 2 | COPIER | A | 0.1 SECOND | A | 8.0 | 20.0 | COMPARATIVE |
| | | PAPER | | LATER | | | | EXAMPLE |
| 9 | 3 | OPP | A | 0.1 SECOND | A | 8.0 | 20.0 | COMPARATIVE |
| | | | | LATER | | | | EXAMPLE |
| 10 | 3 | PET | A | 0.1 SECOND | A | 8.0 | 20.0 | COMPARATIVE |
| | | | | LATER | | | | EXAMPLE |
| 11 | 3 | FINE | A | 0.1 SECOND | A | 8.0 | 20.0 | COMPARATIVE |
| | | PAPER | | LATER | | | | EXAMPLE |
| 12 | 3 | COPIER | A | 0.1 SECOND | A | 8.0 | 20.0 | COMPARATIVE |
| | | PAPER | | LATER | | | | EXAMPLE |
| 13 | 4 | OPP | A | 0.1 SECOND | A | 8.0 | 20.0 | PRESENT |
| | | | | LATER | | | | INVENTION |
| 14 | 4 | PET | A | 0.1 SECOND | A | 8.0 | 20.0 | PRESENT |
| | | | | LATER | | | | INVENTION |
| 15 | 4 | FINE | A | 0.1 SECOND | A | 8.0 | 20.0 | PRESENT |
| | | PAPER | | LATER | | | | INVENTION |
| 16 | 4 | COPIER | A | 0.1 SECOND | A | 8.0 | 20.0 | PRESENT |
| | | PAPER | | LATER | | | | INVENTION |
| 17 | 5 | OPP | A | 0.1 SECOND | A | 8.0 | 20.0 | PRESENT |
| | | | | LATER | | | | INVENTION |
| 18 | 5 | PET | A | 0.1 SECOND | A | 8.0 | 20.0 | PRESENT |
| | | | | LATER | | | | INVENTION |
| 19 | 5 | FINE | A | 0.1 SECOND | A | 8.0 | 20.0 | PRESENT |
| | | PAPER | | LATER | | | | INVENTION |
| 20 | 5 | COPIER | A | 0.1 SECOND | A | 8.0 | 20.0 | PRESENT |
| | | PAPER | | LATER | | | | INVENTION |
| 21 | 6 | OPP | A | 0.1 SECOND | A | 8.0 | 20.0 | PRESENT |
| | | | | LATER | | | | INVENTION |
| 22 | 6 | PET | A | 0.1 SECOND | A | 8.0 | 20.0 | PRESENT |
| | | | | LATER | | | | INVENTION |
| 23 | 6 | FINE | A | 0.1 SECOND | A | 8.0 | 20.0 | PRESENT |
| | | PAPER | | LATER | | | | INVENTION |
| 24 | 6 | COPIER | A | 0.1 SECOND | A | 8.0 | 20.0 | PRESENT |
| | | PAPER | | LATER | | | | INVENTION |
| 25 | 7 | OPP | A | 0.1 SECOND | A | 8.0 | 20.0 | PRESENT |
| | | | | LATER | | | | INVENTION |
| 26 | 7 | PET | A | 0.1 SECOND | A | 8.0 | 20.0 | PRESENT |
| | | | | LATER | | | | INVENTION |
| 27 | 7 | FINE | A | 0.1 SECOND | A | 8.0 | 20.0 | PRESENT |
| | | PAPER | | LATER | | | | INVENTION |
| 28 | 7 | COPIER | A | 0.1 SECOND | A | 8.0 | 20.0 | PRESENT |
| | | PAPER | | LATER | | | | INVENTION |
| 29 | 8 | OPP | A | 0.1 SECOND | A | 8.0 | 20.0 | PRESENT |
| | | | | LATER | | | | INVENTION |
| 30 | 8 | PET | A | 0.1 SECOND | A | 8.0 | 20.0 | PRESENT |
| | | | | LATER | | | | INVENTION |
| 31 | 8 | FINE | A | 0.1 SECOND | A | 8.0 | 20.0 | PRESENT |
| | | PAPER | | LATER | | | | INVENTION |
| 32 | 8 | COPIER | A | 0.1 SECOND | A | 8.0 | 20.0 | PRESENT |
| | | PAPER | | LATER | | | | INVENTION |

TABLE 2-2

| | | | IRRADIATION CONDITIONS OF ACTIVE RAY | | | | | |
|---|---|---|---|---|---|---|---|---|
| | INK | | IRRADIA- | IRRADIATION | | | | |
| | COMPOSI- | | TION | TIME | | MAXIMUM | IRRADIATION | |
| SAMPLE | TION | RECORDING | LIGHT | AFTER | IRRADIATION | ILLUMINANCE | ENERGY | |
| NO. | NO. | MATERIAL | SOURCE | PRINTING | METHOD | (mW/cm²) | (mJ/cm²⁾ | REMARKS |
| 13 | 4 | OPP | A | 0.1 SECOND | A | 8.0 | 20.0 | PRESENT |
| | | | | LATER | | | | INVENTION |
| 14 | 4 | PET | A | 0.1 SECOND | A | 8.0 | 20.0 | PRESENT |
| | | | | LATER | | | | INVENTION |
| 15 | 4 | FINE | A | 0.1 SECOND | A | 8.0 | 20.0 | PRESENT |
| | | PAPER | | LATER | | | | INVENTION |
| 16 | 4 | COPIER | A | 0.1 SECOND | A | 8.0 | 20.0 | PRESENT |
| | | PAPER | | LATER | | | | INVENTION |
| 17 | 5 | OPP | A | 0.1 SECOND | A | 8.0 | 20.0 | PRESENT |
| | | | | LATER | | | | INVENTION |
| 18 | 5 | PET | A | 0.1 SECOND | A | 8.0 | 20.0 | PRESENT |
| | | | | LATER | | | | INVENTION |
| 19 | 5 | FINE | A | 0.1 SECOND | A | 8.0 | 20.0 | PRESENT |
| | | PAPER | | LATER | | | | INVENTION |
| 20 | 5 | COPIER | A | 0.1 SECOND | A | 8.0 | 20.0 | PRESENT |
| | | PAPER | | LATER | | | | INVENTION |
| 21 | 6 | OPP | A | 0.1 SECOND | A | 8.0 | 20.0 | PRESENT |
| | | | | LATER | | | | INVENTION |
| 22 | 6 | PET | A | 0.1 SECOND | A | 8.0 | 20.0 | PRESENT |
| | | | | LATER | | | | INVENTION |
| 23 | 6 | FINE | A | 0.1 SECOND | A | 8.0 | 20.0 | PRESENT |
| | | PAPER | | LATER | | | | INVENTION |
| 24 | 6 | COPIER | A | 0.1 SECOND | A | 8.0 | 20.0 | PRESENT |
| | | PAPER | | LATER | | | | INVENTION |
| 25 | 7 | OPP | A | 0.1 SECOND | A | 8.0 | 20.0 | PRESENT |
| | | | | LATER | | | | INVENTION |
| 26 | 7 | PET | A | 0.1 SECOND | A | 8.0 | 20.0 | PRESENT |
| | | | | LATER | | | | INVENTION |
| 27 | 7 | FINE | A | 0.1 SECOND | A | 8.0 | 20.0 | PRESENT |
| | | PAPER | | LATER | | | | INVENTION |
| 28 | 7 | COPIER | A | 0.1 SECOND | A | 8.0 | 20.0 | PRESENT |
| | | PAPER | | LATER | | | | INVENTION |
| 29 | 8 | OPP | A | 0.1 SECOND | A | 8.0 | 20.0 | PRESENT |
| | | | | LATER | | | | INVENTION |
| 30 | 8 | PET | A | 0.1 SECOND | A | 8.0 | 20.0 | PRESENT |
| | | | | LATER | | | | INVENTION |
| 31 | 8 | FINE | A | 0.1 SECOND | A | 8.0 | 20.0 | PRESENT |
| | | PAPER | | LATER | | | | INVENTION |
| 32 | 8 | COPIER | A | 0.1 SECOND | A | 8.0 | 20.0 | PRESENT |
| | | PAPER | | LATER | | | | INVENTION |

The abbreviations of each recording material in Tables 2-1 and 2-2 are explained below.

OPP: oriented polypropylene

PET: polyethylene terephthalate

Copier paper is a recycled acid-free paper generally used as papers for copier.

Further, the abbreviations of irradiation light source in Tables 2-1 and 2-2 are explained below.

Irradiation light source A: fluorescent light (electrical requirement of power source of less than lkwhr, peak wavelength of 310 nm: special order item, Nippo Elec. Co., Ltd.)

Irradiation method A: line light sources are applied to irradiate from both ends of the recording head.

Irradiation method B: each 10 line light sources are applied to irradiate from both ends of the recording head.

<<Evaluation of an Ink Jet Recording Image>>

The individual images recorded by the above-described image forming methods were subjected to the evaluations below. Each evaluation is conducted on the samples taken after 1 m, 10 m and 100 m of image recording by continuous jetting.

(Evaluation of Text Quality)

Text in 6-point MS-Ming font was printed using Y, M, C, and K colors ink so as to be each desired concentration of color, observed under magnifying glass, and text quality was evaluated according to the following evaluation criteria:

A: no jaggy;

◯: a slight jaggy observed;

Δ: jaggy observed but the text is recognizable, kept in a barely allowable level; and

x: strong jaggy, the text blurred, practically not available.

(Evaluation of Durability to Color Mixing (Blotting))

The degree of blotting which is seen between adjacent dots of different colors is visually observed under magnifying glass. The degree of color mixing is evaluated according to the criteria below:

⊚: adjacent dots keep true circular form without blotting;

◯: adjacent dots keep nearly true circular form and hardly show blotting;

Δ: adjacent dots blot and deform a little, but keep a barely allowable level; and

x: adjacent dots blot and mix, and are unavailable.

(Evaluation of Image Flatness)

The surface of the individual images taken after printing 1, 10 and 100 m were visually observed so as to evaluate image flatness according to the criteria below:

⊚: no convexity of the image, the flatness is remarkably fine;

◯: convexity of the image is observed in some part, there has little problem in practical use;

Δ: convexity of image is observed, but kept a border quality in practical use; and

X: severe convexity of the image observed, the image quality is degraded and has a problem in practical use.

Results of the evaluations based on the above criteria are shown in Tables 3-1 and 3-2.

TABLE 3

| | SAMPLE | | | SAMPLE | | | SAMPLE | | | |
|---|---|---|---|---|---|---|---|---|---|---|
| | AFTER PRINTING 1 m | | | AFTER PRINTING 10 m | | | AFTER PRINTING 100 m | | | |
| | | DURA- | | | DURA- | | | DURA- | | |
| | | BILITY | | | BILITY | | | BILITY | | |
| | | TO | IMAGE | | TO | IMAGE | | TO | IMAGE | |
| SAMPLE | TEXT | COLOR | FLAT- | TEXT | COLOR | FLAT- | TEXT | COLOR | FLAT- | |
| NO. | QUALITY | MIXING | NESS | QUALITY | MIXING | NESS | QUALITY | MIXING | NESS | REMARKS |
| 1 | Δ | Δ | X | X | Δ | X | X | X | X | COMPARATIVE |
| | | | | | | | | | | EXAMPLE |
| 2 | Δ | Δ | X | Δ | Δ | X | X | X | X | COMPARATIVE |
| | | | | | | | | | | EXAMPLE |
| 3 | X | X | ◯ | X | X | ◯ | X | X | ◯ | COMPARATIVE |
| | | | | | | | | | | EXAMPLE |
| 4 | X | X | ◯ | X | X | ◯ | X | X | ◯ | COMPARATIVE |
| | | | | | | | | | | EXAMPLE |
| 5 | Δ | Δ | X | Δ | Δ | X | X | X | X | COMPARATIVE |
| | | | | | | | | | | EXAMPLE |
| 6 | Δ | Δ | X | Δ | Δ | X | X | X | X | COMPARATIVE |
| | | | | | | | | | | EXAMPLE |
| 7 | X | X | ◯ | X | X | ◯ | X | X | ◯ | COMPARATIVE |
| | | | | | | | | | | EXAMPLE |
| 8 | Δ | Δ | ◯ | X | X | ◯ | X | X | ◯ | COMPARATIVE |
| | | | | | | | | | | EXAMPLE |
| 9 | Δ | Δ | X | Δ | Δ | X | X | X | X | COMPARATIVE |
| | | | | | | | | | | EXAMPLE |
| 10 | Δ | Δ | X | Δ | Δ | X | X | X | X | COMPARATIVE |
| | | | | | | | | | | EXAMPLE |
| 11 | X | X | ◯ | Δ | Δ | ◯ | X | X | ◯ | COMPARATIVE |
| | | | | | | | | | | EXAMPLE |
| 12 | Δ | Δ | ◯ | Δ | Δ | ◯ | X | X | ◯ | COMPARATIVE |
| | | | | | | | | | | EXAMPLE |
| 13 | ◯ | ◯ | ◯ | Δ | ◯ | ◯ | Δ | Δ | Δ | PRESENT |
| | | | | | | | | | | INVENTION |
| 14 | ◯ | ◯ | ◯ | Δ | ◯ | ◯ | Δ | Δ | Δ | PRESENT |
| | | | | | | | | | | INVENTION |
| 15 | Δ | Δ | ◯ | Δ | Δ | ◯ | Δ | Δ | Δ | PRESENT |
| | | | | | | | | | | INVENTION |
| 16 | ◯ | ◯ | ◯ | Δ | ◯ | ◯ | Δ | ◯ | Δ | PRESENT |
| | | | | | | | | | | INVENTION |
| 17 | ◯ | ◯ | ◯ | ◯ | ◯ | ◯ | Δ | Δ | ◯ | PRESENT |
| | | | | | | | | | | INVENTION |
| 18 | ◯ | ◯ | ◯ | ◯ | ◯ | ◯ | Δ | Δ | ◯ | PRESENT |
| | | | | | | | | | | INVENTION |
| 19 | ◯ | ◯ | ◯ | Δ | Δ | ◯ | Δ | Δ | ◯ | PRESENT |
| | | | | | | | | | | INVENTION |
| 20 | ◯ | ◯ | ◯ | ◯ | ◯ | ◯ | Δ | Δ | ◯ | PRESENT |
| | | | | | | | | | | INVENTION |
| 21 | ⊚ | ⊚ | ◯ | ◯ | ◯ | ◯ | ◯ | ◯ | ◯ | PRESENT |
| | | | | | | | | | | INVENTION |
| 22 | ⊚ | ⊚ | ◯ | ◯ | ◯ | ◯ | ◯ | ◯ | ◯ | PRESENT |
| | | | | | | | | | | INVENTION |
| 23 | ⊚ | ⊚ | ◯ | ◯ | ◯ | ◯ | ◯ | ◯ | ◯ | PRESENT |
| | | | | | | | | | | INVENTION |
| 24 | ⊚ | ⊚ | ⊚ | ⊚ | ⊚ | ◯ | ◯ | ◯ | ◯ | PRESENT |
| | | | | | | | | | | INVENTION |
| 25 | ⊚ | ⊚ | ⊚ | ⊚ | ⊚ | ◯ | ⊚ | ⊚ | ◯ | PRESENT |
| | | | | | | | | | | INVENTION |
| 26 | ⊚ | ⊚ | ⊚ | ⊚ | ⊚ | ◯ | ⊚ | ⊚ | ◯ | PRESENT |
| | | | | | | | | | | INVENTION |
| 27 | ⊚ | ⊚ | ⊚ | ◯ | ◯ | ⊚ | ◯ | ◯ | ◯ | PRESENT |
| | | | | | | | | | | INVENTION |
| 28 | ⊚ | ⊚ | ⊚ | ⊚ | ⊚ | ⊚ | ◯ | ◯ | ◯ | PRESENT |
| | | | | | | | | | | INVENTION |
| 29 | ⊚ | ⊚ | ⊚ | ⊚ | ⊚ | ⊚ | ⊚ | ⊚ | ⊚ | PRESENT |
| | | | | | | | | | | INVENTION |
| 30 | ⊚ | ⊚ | ⊚ | ⊚ | ⊚ | ⊚ | ⊚ | ⊚ | ⊚ | PRESENT |
| | | | | | | | | | | INVENTION |
| 31 | ⊚ | ⊚ | ⊚ | ⊚ | ⊚ | ⊚ | ◯ | ◯ | ⊚ | PRESENT |
| | | | | | | | | | | INVENTION |
| 32 | ⊚ | ⊚ | ⊚ | ⊚ | ⊚ | ⊚ | ◯ | ◯ | ⊚ | PRESENT |
| | | | | | | | | | | INVENTION |

TABLE 3-2

| SAMPLE | SAMPLE | SAMPLE |
|---|---|---|
| AFTER PRINTING 1 m | AFTER PRINTING 10 m | AFTER PRINTING 100 m |

| | | DURA- | | | DURA- | | | DURA- | | |
|---|---|---|---|---|---|---|---|---|---|---|
| | | BILITY | IMAGE | | BILITY | IMAGE | | BILITY | IMAGE | |
| SAMPLE | TEXT | TO COLOR | FLAT- | TEXT | TO COLOR | FLAT- | TEXT | TO COLOR | FLAT- | |
| NO. | QUALITY | MIXING | NESS | QUALITY | MIXING | NESS | QUALITY | MIXING | NESS | REMARKS |
| 13 | ◯ | ◯ | ◯ | Δ | ◯ | ◯ | Δ | Δ | Δ | PRESENT |
| | | | | | | | | | | INVENTION |
| 14 | ◯ | ◯ | ◯ | Δ | ◯ | ◯ | Δ | Δ | Δ | PRESENT |
| | | | | | | | | | | INVENTION |
| 15 | Δ | Δ | ◯ | Δ | Δ | ◯ | Δ | Δ | Δ | PRESENT |
| | | | | | | | | | | INVENTION |
| 16 | ◯ | ◯ | ◯ | Δ | ◯ | ◯ | Δ | ◯ | Δ | PRESENT |
| | | | | | | | | | | INVENTION |
| 17 | ◯ | ◯ | ◯ | ◯ | ◯ | ◯ | Δ | Δ | ◯ | PRESENT |
| | | | | | | | | | | INVENTION |
| 18 | ◯ | ◯ | ◯ | ◯ | ◯ | ◯ | Δ | Δ | ◯ | PRESENT |
| | | | | | | | | | | INVENTION |
| 19 | ◯ | ◯ | ◯ | Δ | Δ | ◯ | Δ | Δ | ◯ | PRESENT |
| | | | | | | | | | | INVENTION |
| 20 | ◯ | ◯ | ◯ | ◯ | ◯ | ◯ | Δ | Δ | ◯ | PRESENT |
| | | | | | | | | | | INVENTION |
| 21 | ⊚ | ⊚ | ◯ | ◯ | ◯ | ◯ | ◯ | ◯ | ◯ | PRESENT |
| | | | | | | | | | | INVENTION |
| 22 | ⊚ | ⊚ | ◯ | ◯ | ◯ | ◯ | ◯ | ◯ | ◯ | PRESENT |
| | | | | | | | | | | INVENTION |
| 23 | ⊚ | ⊚ | ◯ | ◯ | ◯ | ◯ | ◯ | ◯ | ◯ | PRESENT |
| | | | | | | | | | | INVENTION |
| 24 | ⊚ | ⊚ | ⊚ | ⊚ | ⊚ | ◯ | ◯ | ◯ | ◯ | PRESENT |
| | | | | | | | | | | INVENTION |
| 25 | ⊚ | ⊚ | ⊚ | ⊚ | ⊚ | ◯ | ⊚ | ⊚ | ◯ | PRESENT |
| | | | | | | | | | | INVENTION |
| 26 | ⊚ | ⊚ | ⊚ | ⊚ | ⊚ | ◯ | ⊚ | ⊚ | ◯ | PRESENT |
| | | | | | | | | | | INVENTION |
| 27 | ⊚ | ⊚ | ⊚ | ◯ | ◯ | ⊚ | ◯ | ◯ | ◯ | PRESENT |
| | | | | | | | | | | INVENTION |
| 28 | ⊚ | ⊚ | ⊚ | ⊚ | ⊚ | ⊚ | ◯ | ◯ | ◯ | PRESENT |
| | | | | | | | | | | INVENTION |
| 29 | ⊚ | ⊚ | ⊚ | ⊚ | ⊚ | ⊚ | ⊚ | ⊚ | ⊚ | PRESENT |
| | | | | | | | | | | INVENTION |
| 30 | ⊚ | ⊚ | ⊚ | ⊚ | ⊚ | ⊚ | ⊚ | ⊚ | ⊚ | PRESENT |
| | | | | | | | | | | INVENTION |
| 31 | ⊚ | ⊚ | ⊚ | ⊚ | ⊚ | ⊚ | ◯ | ◯ | ⊚ | PRESENT |
| | | | | | | | | | | INVENTION |
| 32 | ⊚ | ⊚ | ⊚ | ⊚ | ⊚ | ⊚ | ◯ | ◯ | ⊚ | PRESENT |
| | | | | | | | | | | INVENTION |

As is obvious from these evaluation results, the image forming method using the ink composition of the present invention was successful in forming images of high definition while ensuring superior text quality, durability to color mixing and image flatness, even if the image is printed continuously.

Another evaluations are conducted in the same condition except size of the recording material is changed to A4. Text quality, durability to color mixing and image flatness of the samples of 5th, 50th, and 500th sheet in continuous printing are evaluated. The obtained results were respectively as same as the results in which samples taken after 1 m, 10 m and 100 m of printing were evaluated as described above.

### Example 2

<<Preparation of the Ink Composition>>

The ink compositions of 9 to 12 in Table 4 are respectively prepared. Herein, the numeral numbers in Table 4 denote percentage by mass in the ink composition.

TABLE 4

| | | TYPE OF INK | | | | |
|---|---|---|---|---|---|---|
| | | K | C | M | Y | W |
| | | TYPE OF COLOR MATERIAL | | | | |
| INK | | COLOR | COLOR | COLOR | COLOR | COLOR |
| COMPOSITION | | MATERIAL | MATERIAL | MATERIAL | MATERIAL | MATERIAL |
| NUMBER | | 1 | 2 | 3 | 4 | 5 |
| 9 | AMOUNT OF COLOR MATERIAL | 12.0 | 12.0 | 12.0 | 12.0 | 12.0 |
| (COMPARATIVE | CURABLE COMPOUND: A3-1 | 43.9 | 43.9 | 43.9 | 43.9 | 43.9 |
| EXAMPLE) | PHOTOINITIATOR: TX-1 | 4.0 | 4.0 | 4.0 | 4.0 | 4.0 |
| | TRIETHANOLAMINE | 0.1 | 0.1 | 0.1 | 0.1 | 0.1 |
| | WATER | 40.0 | 40.0 | 40.0 | 40.0 | 40.0 |
| 10 | AMOUNT OF COLOR MATERIAL | 12.0 | 12.0 | 12.0 | 12.0 | 12.0 |
| (PRESENT | CURABLE COMPOUND: A3-1 | 43.8 | 43.8 | 43.8 | 43.8 | 43.8 |
| INVENTION) | PHOTOINITIATOR: TX-1 | 4.0 | 4.0 | 4.0 | 4.0 | 4.0 |
| | TRIETHANOLAMINE | 0.1 | 0.1 | 0.1 | 0.1 | 0.1 |
| | WATER | 40.0 | 40.0 | 40.0 | 40.0 | 40.0 |
| | DETERGENT 5 | 0.1 | 0.1 | 0.1 | 0.1 | 0.1 |
| 11 | AMOUNT OF COLOR MATERIAL | 12.0 | 12.0 | 12.0 | 12.0 | 12.0 |
| (PRESENT | CURABLE COMPOUND: A3-1 | 43.8 | 43.8 | 43.8 | 43.8 | 43.8 |
| INVENTION) | PHOTOINITIATOR: TX-1 | 4.0 | 4.0 | 4.0 | 4.0 | 4.0 |
| | TRIETHANOLAMINE | 0.1 | 0.1 | 0.1 | 0.1 | 0.1 |
| | WATER | 40.0 | 40.0 | 40.0 | 40.0 | 40.0 |
| | DETERGENT 6 | 0.1 | 0.1 | 0.1 | 0.1 | 0.1 |
| 12 | AMOUNT OF COLOR MATERIAL | 12.0 | 12.0 | 12.0 | 12.0 | 12.0 |
| (PRESENT | CURABLE COMPOUND: A3-1 | 42.9 | 42.9 | 42.9 | 42.9 | 42.9 |
| INVENTION) | PHOTOINITIATOR: TX-1 | 4.0 | 4.0 | 4.0 | 4.0 | 4.0 |
| | TRIETHANOLAMINE | 0.1 | 0.1 | 0.1 | 0.1 | 0.1 |
| | WATER | 40.0 | 40.0 | 40.0 | 40.0 | 40.0 |
| | DETERGENT 6 | 0.1 | 0.1 | 0.1 | 0.1 | 0.1 |

The abbreviations of the additives used in the preparations of above ink compositions 9 to 12 are in accordance with the description of the compounds in example 1.

The polymerizable compound A3-2 is one described as A3-2 in above formula, and was synthesized.

<<Formation of an Ink Jet Image>>

Images are formed using the ink jet recording apparatus described in example 1 under the conditions shown in Table 5.

The irradiation light source B is a cold cathode ray tube (electrical requirement of power source of less than 1 kw·hr, 308 nm: special order item of Hybec Corporation). In irradiation method B, each 10 line light sources were applied to irradiate from both ends of the recording head as described above.

TABLE 5

| | | | IRRADIATION CONDITIONS | | | | | |
|---|---|---|---|---|---|---|---|---|
| | | | OF ACTIVE RAY | | | | | |
| | | | | IR- | | | | |
| | | | IR- | RADIA- | | | IR- | |
| | INK | | RADIA- | TION | IR- | MAXIMUM | RADIA- | |
| | COMPO- | | TION | TIME | RADIA- | ILLUMIN- | TION | |
| SAMPLE | SITION | RECORDING | LIGHT | AFTER | TION | ANCE | ENERGY | |
| NO. | NO. | MATERIAL | SOURCE | PRINTING | METHOD | (mW/cm²) | (mJ/cm²) | REMARKS |
| 33 | 9 | OPP | B | 0.1 SECOND | B | 12.0 | 11.0 | COMPARATIVE |
| | | | | LATER | | | | EXAMPLE |
| 34 | 9 | PET | B | 0.1 SECOND | B | 12.0 | 11.0 | COMPARATIVE |
| | | | | LATER | | | | EXAMPLE |
| 35 | 9 | FINE PAPER | B | 0.1 SECOND | B | 12.0 | 11.0 | COMPARATIVE |
| | | | | LATER | | | | EXAMPLE |
| 36 | 10 | OPP | B | 0.1 SECOND | B | 12.0 | 11.0 | PRESENT |
| | | | | LATER | | | | INVENTION |
| 37 | 10 | PET | B | 0.1 SECOND | B | 12.0 | 11.0 | PRESENT |
| | | | | LATER | | | | INVENTION |
| 38 | 10 | FINE PAPER | B | 0.1 SECOND | B | 12.0 | 11.0 | PRESENT |
| | | | | LATER | | | | INVENTION |
| 39 | 11 | OPP | B | 0.1 SECOND | B | 12.0 | 11.0 | PRESENT |
| | | | | LATER | | | | INVENTION |
| 40 | 11 | PET | B | 0.1 SECOND | B | 12.0 | 11.0 | PRESENT |
| | | | | LATER | | | | INVENTION |
| 41 | 11 | FINE PAPER | B | 0.1 SECOND | B | 12.0 | 11.0 | PRESENT |
| | | | | LATER | | | | INVENTION |
| 42 | 12 | OPP | B | 0.1 SECOND | B | 12.0 | 11.0 | PRESENT |
| | | | | LATER | | | | INVENTION |
| 43 | 12 | PET | B | 0.1 SECOND | B | 12.0 | 11.0 | PRESENT |
| | | | | LATER | | | | INVENTION |
| 44 | 12 | FINE PAPER | B | 0.1 SECOND | B | 12.0 | 11.0 | PRESENT |
| | | | | LATER | | | | INVENTION |

<<Evaluation of an Ink Jet Recording Image>>

As same as the method in example 1, the individual images recorded by the above-described image forming methods were subjected to the evaluations of text quality, durability to color mixing (blotting) and image flatness. Each evaluation is conducted on the samples taken after 1 m, 10 m and 100 m of image recording by continuous ejecting. The obtained results are shown in Table 6.

TABLE 6

| | SAMPLE | | | SAMPLE | | | SAMPLE | | | |
|---|---|---|---|---|---|---|---|---|---|---|
| | AFTER PRINTING 1 m | | | AFTER PRINTING 10 m | | | AFTER PRINTING 100 m | | | |
| | | DURA- | | | DURA- | | | DURA- | | |
| | | BILITY | | | BILITY | | | BILITY | | |
| | | TO | IMAGE | | TO | IMAGE | | TO | IMAGE | |
| SAMPLE | TEXT | COLOR | FLAT- | TEXT | COLOR | FLAT- | TEXT | COLOR | FLAT- | |
| NO. | QUALITY | MIXING | NESS | QUALITY | MIXING | NESS | QUALITY | MIXING | NESS | REMARKS |
| 33 | Δ | Δ | X | X | Δ | X | X | X | X | COMPARATIVE |
| | | | | | | | | | | EXAMPLE |
| 34 | Δ | Δ | X | X | Δ | X | X | X | X | COMPARATIVE |
| | | | | | | | | | | EXAMPLE |
| 35 | Δ | Δ | ◯ | X | Δ | ◯ | X | X | ◯ | COMPARATIVE |
| | | | | | | | | | | EXAMPLE |
| 36 | ⊚ | ⊚ | ◯ | ⊚ | ⊚ | ◯ | ◯ | ◯ | ◯ | PRESENT |
| | | | | | | | | | | INVENTION |
| 37 | ⊚ | ⊚ | ◯ | ⊚ | ⊚ | ◯ | ◯ | ◯ | ◯ | PRESENT |
| | | | | | | | | | | INVENTION |
| 38 | ⊚ | ⊚ | ◯ | ◯ | ◯ | ◯ | ◯ | ◯ | ◯ | PRESENT |
| | | | | | | | | | | INVENTION |
| 39 | ⊚ | ⊚ | ⊚ | ⊚ | ⊚ | ◯ | ⊚ | ⊚ | ◯ | PRESENT |
| | | | | | | | | | | INVENTION |
| 40 | ⊚ | ⊚ | ⊚ | ⊚ | ⊚ | ◯ | ⊚ | ⊚ | ◯ | PRESENT |
| | | | | | | | | | | INVENTION |
| 41 | ⊚ | ⊚ | ⊚ | ◯ | ◯ | ⊚ | ◯ | ◯ | ◯ | PRESENT |
| | | | | | | | | | | INVENTION |
| 42 | ⊚ | ⊚ | ⊚ | ⊚ | ⊚ | ⊚ | ⊚ | ⊚ | ⊚ | PRESENT |
| | | | | | | | | | | INVENTION |
| 43 | ⊚ | ⊚ | ⊚ | ⊚ | ⊚ | ⊚ | ⊚ | ⊚ | ⊚ | PRESENT |
| | | | | | | | | | | INVENTION |
| 44 | ⊚ | ⊚ | ⊚ | ⊚ | ⊚ | ⊚ | ◯ | ◯ | ⊚ | PRESENT |
| | | | | | | | | | | INVENTION |

As is obvious from these evaluation results, the image forming method using the ink composition of the present invention was successful in forming images of high definition while ensuring superior text quality, durability to color mixing and image flatness, even if the image is printed continuously.

Another evaluations are conducted in the same condition except size of the recording material is changed to A4. Text quality, durability to color mixing and image flatness of the samples of 5th, 50th, and 500th sheet in continuous printing are evaluated. The obtained results were respectively as same as the results in which samples taken after 1 m, 10 m and 100 m of printing were evaluated as described above.

The entire disclosure of Japanese Patent Application No. 2003-33032 filed on Feb. 12, 2003 including specification, claims, drawings and summary is incorporated herein by reference in its entirety.

What is claimed is:

1. Active ray curable type aqueous ink, which is jetted onto a recording material by a recording head comprising nozzles which selectively controls ejection of ink droplets, and is subsequently cured by irradiation of active ray, comprising:
a light curable type aqueous resin composition comprising a polymerizable compound which polymerizes with radical polymerization by water and active ray, and aqueous photo polymerization initiator which generates free radicals by active ray; and non-ionic surfactant.

2. The aqueous ink of claim 1, wherein the non-ionic surfactant is fluorine system surfactant comprising perfluoroalkyl group in a molecule.

3. The aqueous ink of claim 1, wherein content of the non-ionic surfactant is 10 to 10,000 ppm.

4. An image forming method in which active ray curable type aqueous ink which is cured by active ray is jetted onto a recording material by a recording head comprising nozzles which selectively controls ejection of ink droplets, wherein:
the active ray curable type aqueous ink comprises a light curable type aqueous resin composition comprising a polymerizable compound which polymerizes with radical polymerization by water and active ray, and aqueous photo polymerization initiator which generates free radicals by active ray, and non-ionic surfactant.

5. The image forming method of claim 4, in which the non-ionic surfactant is fluorine system surfactant comprising perfluoroalkyl group in a molecule.

6. The image forming method of claim 4, in which the active ray curable type aqueous ink contains the non-ionic surfactant of 10 to 10,000 ppm.

7. Printed matter which is produced by jetting the active ray curable type aqueous ink of claim 1 onto an unabsorbent recording material.

8 Printed matter which is produced by jetting the active ray curable type aqueous ink of claim 1 onto an absorbent recording material.

9. Printed matter which is produced by the image forming method of claim 4, by using an unabsorbent recording material.

10. Printed matter which is produced in the image forming method of claim 4, by using an absorbent recording material.
